(19) United States
(12) Patent Application Publication
(10) Pub. No.: US 2010/0321640 A1
(43) Pub. Date: Dec. 23, 2010

(54) PROJECTION DISPLAY CHIP

(75) Inventors: Wen Yung YEH, Hukou Township (TW); Yu Hung Chuang, Xinzhuang City (TW); Chia Hsin Chao, Dadu Shiang (TW); Chia Ling Li, Zhonghe City (TW); Tse Peng Chen, Hsinchu City (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH Institute, Chutung (TW)

(21) Appl. No.: 12/781,419

(22) Filed: May 17, 2010

Related U.S. Application Data
(60) Provisional application No. 61/219,331, filed on Jun. 22, 2009.

(51) Int. Cl. G03B 21/00

(52) U.S. Cl. 353/31

(57) ABSTRACT

A projection display chip comprises a micro light emitting array comprising a plurality of micro LEDs, a micro collimation array comprising a plurality of micro collimation devices, and a projection micro lens array comprising a plurality of micro lenses. Each micro LED has a corresponding driving circuit device. The plurality of micro lenses has different optical axes to enlarge projected images.

### CROSS-REFERENCE TO RELATED APPLICATIONS

This application is an application under 35 USC 111(a) and claims priority under 35 USC 119 from Provisional Application Ser. No. 61/219,331 filed Jun. 22, 2009 under 35 USC 111(b), entitled “Micro-Light-Emitting Diode (Micro-LED) Projection Chip,” the disclosure of which is incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a projection display chip.

2. Description of Related Art

Including Information Disclosed Under 37 CFR 1.97 and 37 CFR 1.98.

Micro projectors, also known as pico projectors, mobile projectors or pocket projectors, can be categorized into two types: stand-alone micro projectors or embedded micro projectors. A stand-alone micro projector is a projector which is not combined with any other device. An embedded micro projector, on the other hand, is embedded in another device, such as a cellular phone, a digital camera or a notebook computer. To embed a projector into a device, some technical issues, such as miniaturization, power consumption and manufacturing costs, have to be considered, and of these considerations miniaturization may be the most critical. For example, some cellular phone manufacturers require the embedded micro projector to have a volume smaller than 1 cm³ or a thickness less than 7 millimeters.

The limitations to popularizing micro projectors are the large size, high power consumption, and low light output of the light projecting engine therein. A typical light projecting engine comprises a light source, collimation lenses, a displaying device, a polarizer and projecting lenses. It is difficult, if not impossible, to assemble these components together and meet the size requirement at the same time. Further, the low polarization efficiency of the collimation lenses, the displaying device and the polarizer cause high power consumption and low light output.

Accordingly, there is a need to produce a projection display chip, which can overcome the issues of miniaturization, power consumption and manufacturing costs of conventional projecting systems.

### BRIEF SUMMARY OF THE INVENTION

The present invention provides a projection display chip, which can integrate light sources of traditional projectors, display devices (such as digital light processor (DLP), liquid crystal on silicon (LCoS) and liquid crystal displayer (LCD)) and optic lenses into a single chip without external light sources or projection lenses. Therefore, the projection display chip of this disclosure exhibits small size and high efficiency such that it can be easily integrated into a mobile device, such as a cellular phone.

One embodiment discloses a projection display chip, comprising a micro light emitting array and a micro collimation array. The micro light emitting array includes a plurality of micro light emitting units, wherein each micro emitting unit has a driving circuit device. The micro collimation array is fabricated on the micro light emitting array and includes a plurality of micro collimation devices.

Another embodiment discloses a projection display chip, comprising a micro light emitting array and a projection micro lens array. The micro light emitting array includes a plurality of micro light emitting units, wherein each micro emitting unit has a switching device. The projection micro lens array is fabricated on the micro light emitting array and includes a plurality of micro lenses with different light axes to enlarge projected images.

Another embodiment discloses a projection display chip, comprising a micro light emitting array, a micro collimation array and a projection micro lens array. The micro light emitting array includes a plurality of micro light emitting units, wherein each micro emitting unit has a driving circuit device. The micro collimation array is fabricated on the micro light emitting array and includes a plurality of micro collimation devices. The projection micro lens array is fabricated on the micro collimation array and includes a plurality of micro lenses with different light axes to enlarge projected images.

Another embodiment discloses a projection display chip, comprising a micro light emitting array and a projection micro lens array. The micro light emitting array includes a plurality of micro light emitting units, wherein each micro emitting unit has a driving circuit device. The projection micro lens array is fabricated on the micro light emitting array and includes a plurality of adjustable micro lenses.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 shows a schematic view of the architecture of a projection display chip according to an exemplary embodiment;

FIG. 2 shows a schematic view of the architecture of a projection display chip according to another exemplary embodiment;

FIG. 3 shows a schematic view of the architecture of a projection display chip according to another exemplary embodiment;

FIG. 4 shows a schematic view of the architecture of a micro lens array according to one exemplary embodiment;

FIG. 5 shows a schematic view of the architecture of micro apertures with surface plasmonic effect according to one exemplary embodiment;

FIG. 6 shows a schematic view of the architecture of a micro ring type structure according to one exemplary embodiment;

FIG. 7 shows a schematic view of the architecture of a photonic crystal array structure according to one exemplary embodiment;

FIG. 8 shows a schematic view of a part of a micro light controlling structure according to one exemplary embodiment; and

FIG. 9 shows a schematic view of the arrangement relation of the axis of the lens unit of the poly-axial micro projection lens array according to one exemplary embodiment.

### DETAILED DESCRIPTION OF THE INVENTION

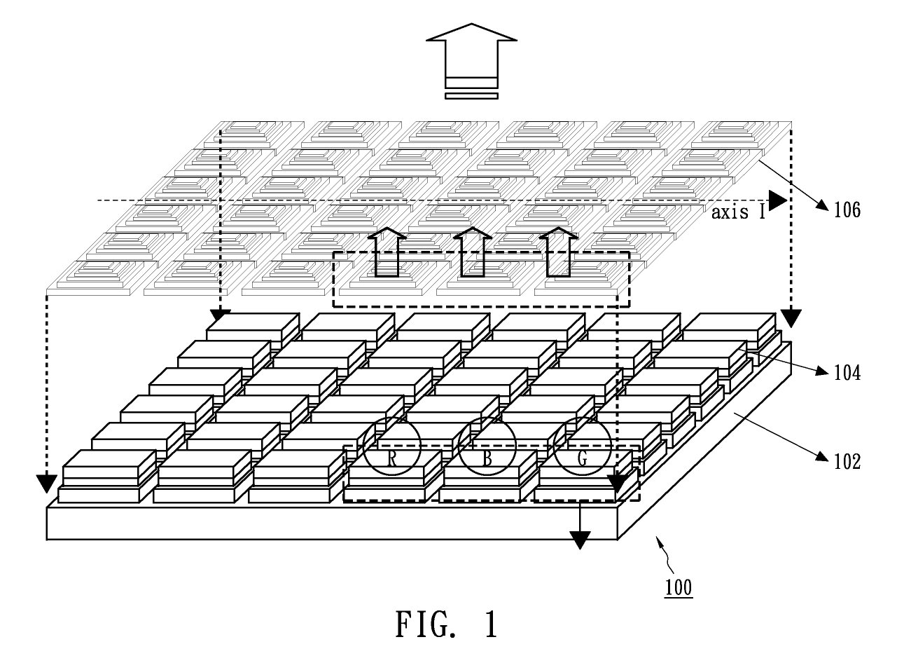

FIG. 1 shows the architecture of a projection display chip according to an exemplary embodiment. The projection display chip 100 comprises a driving circuit device 102, a micro-LED array 104 and a micro light controlling structure 106. As shown in FIG. 1, the projection display chip 100 integrates a plurality of micro-LEDs into an array in a single chip, wherein the plurality of micro-LEDs comprises red, blue and green LEDs, so as to display images in full color, wherein a pixel of red, blue and green emitter comprises a red LED, a blue LED and a green LED. The driving circuit device 102 drives the micro-LED array 104. The projection display chip 100 also comprises an embedded active addressing control circuit to control the micro-LEDs individually to display images. The micro light controlling structure 106 is formed on or is attached to each micro-LED for focusing and projecting to produce a directional light output. The micro light controlling structure 106 comprises a collimation device, a micro lens and an active adjustable lens.

In some embodiments, the micro-LED array 104 can be replaced by a micro laser diode array. In other embodiments, the micro-LED array 104 is implemented by organic LEDs. In some embodiments, the driving circuit device 102 is implemented by thin-film transistors or MOS transistors. In some embodiments, the micro-LED array 104 is adjustable by electronic signals.

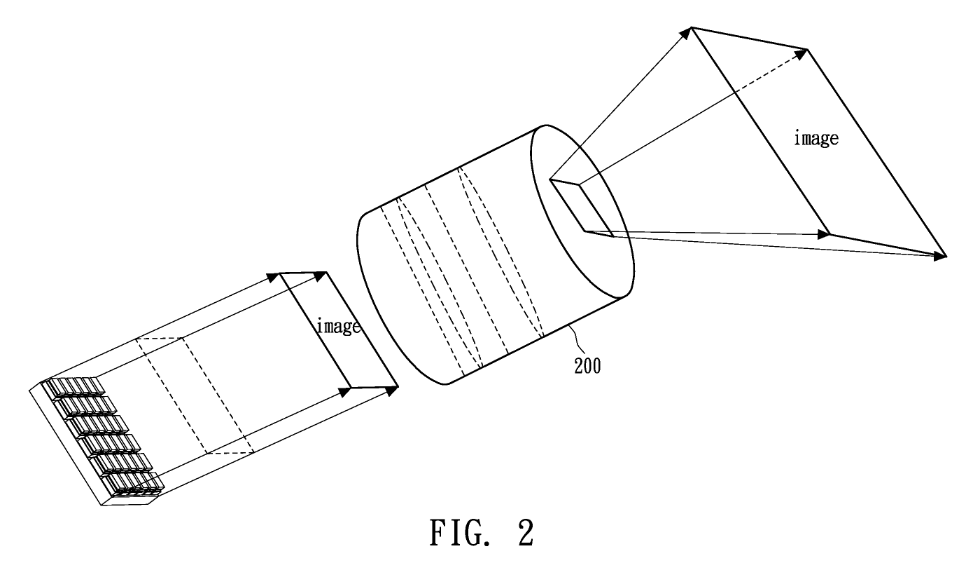

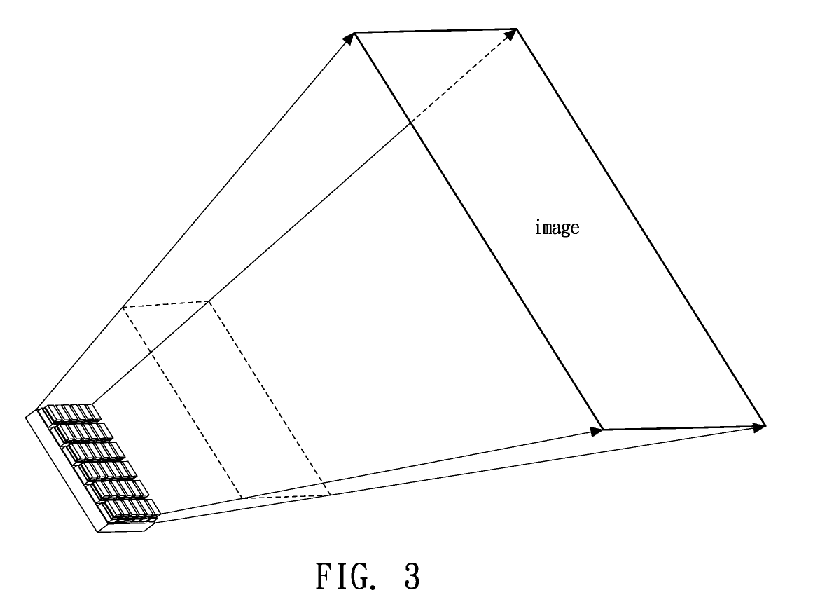

The projection display chip 100 can be combined with a projection lens 200 to display a focused projection as shown in FIG. 2, or without a projection lens to display a focus-free projection as shown in FIG. 3. For different applications, the micro optical structure of the projection display chip 100 can be adjusted accordingly.

The micro light controlling structure 106 is an important feature in this disclosure. The micro light controlling structure 106 is required to efficiently focus the light emitted from each micro-LED and to prevent crosstalk among different micro-LEDs from affecting the image quality.

In this disclosure, crosstalk refers to the spatial interference of the light emitted from the pixels. The size of each pixel in the micro array is extremely small (about 5 micrometers). Due to the small size and the highly concentrated arrangement of these pixels, crosstalk between different pixels must be carefully avoided. The micro light controlling structure 106 in the embodiments of this disclosure provides different means for eliminating the crosstalk problems. As long as the degree of collimation of light form of each pixel is high enough, for example as in limiting the angle of the light outputted from the micro-LEDs to within a certain degree (e.g. <±11°, <±8° or <±2°, depending on the image quality and the micro light controlling structure 106), the crosstalk problem can be overcome.

Therefore, the micro light controlling structure 106 according to the embodiments of this disclosure further comprises micro collimation devices, such as a micro lens array, micro apertures with surface plasmonic effect, a micro ring type structure, or a photonic crystal array. These micro collimation devices collimate the light emitted from the micro-LEDs toward one direction such that the angle of the light emitted from the micro-LEDs is limited to within certain degrees (such as <±11°, <±8° or)<±2°. The manufacture of these micro collimation devices comprises attaching these micro collimation devices to the surface of the micro-LEDs or etching the surface of the micro-LEDs such that the light is collimated by the micro-LEDs.

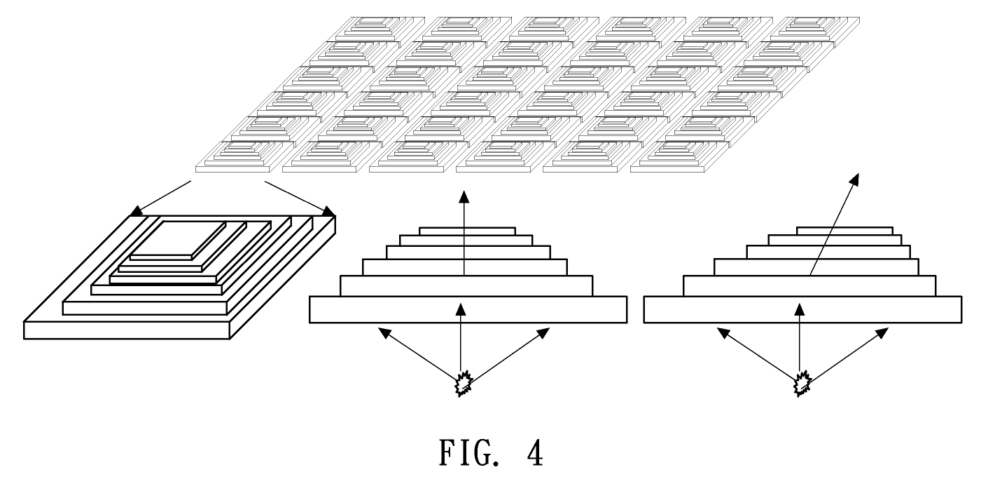

FIG. 4 shows the architecture of a micro lens array according to one exemplary embodiment. As shown in FIG. 4, which shows the cross-section of one micro lens, transparent dielectrics are stacked to form the micro projection lens array, and the stacking pattern of each micro light source is adjusted to form a desired light direction.

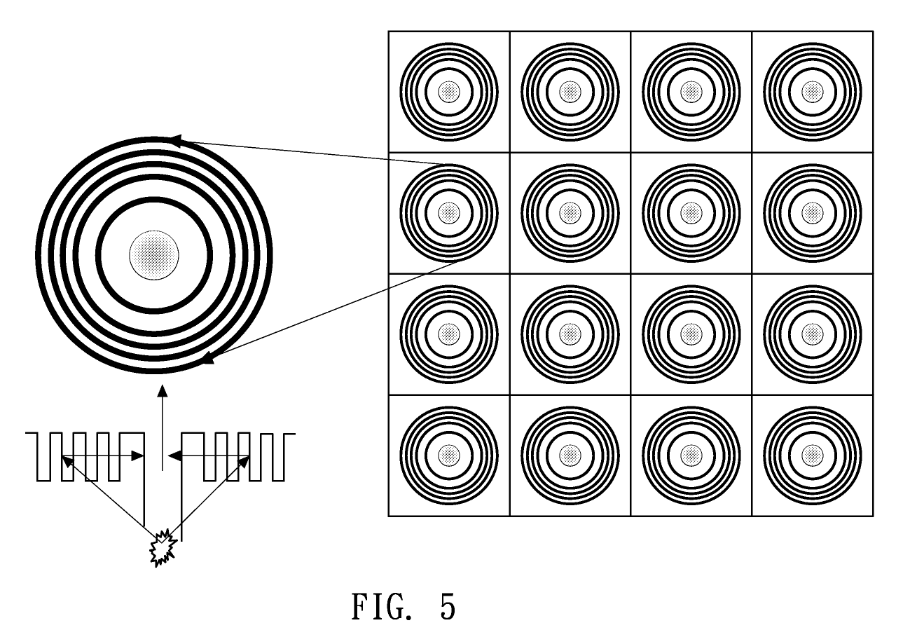

FIG. 5 shows the architecture of micro apertures with surface plasmonic effect according to one exemplary embodiment. As shown in FIG. 5, which shows the top view of the micro apertures with surface plasmonic effect, the top view of a micro aperture and the side view of a micro aperture, the light field of the micro apertures with surface plasmonic effect exhibits high directivity.

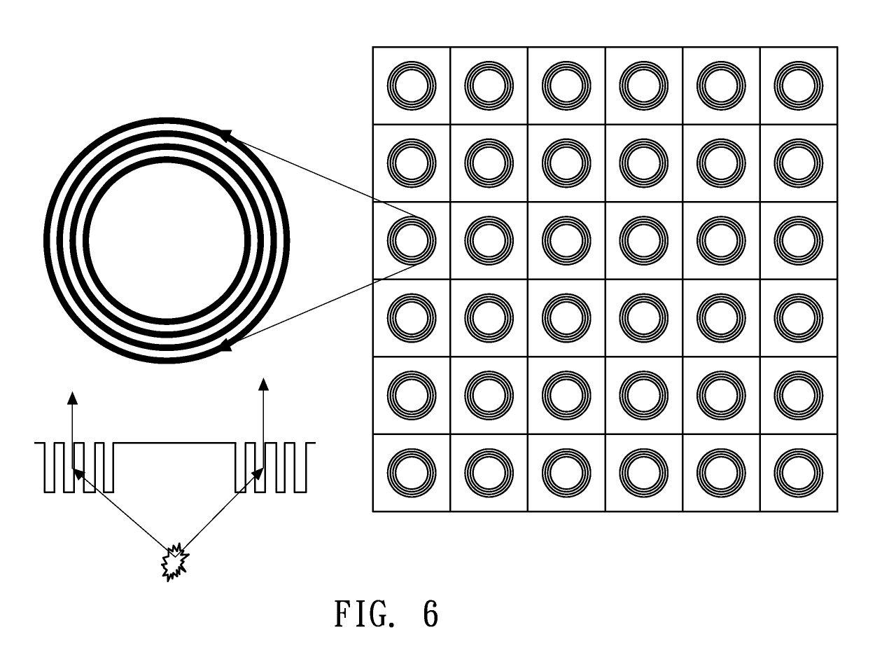

FIG. 6 shows the architecture of a micro ring type structure according to one exemplary embodiment. As shown in FIG. 6, which shows the top view of the micro ring type structure, the top view of a micro ring and the side view of a micro ring, the micro-ring type collimation lens array is formed by forming a micro-ring diffraction unit on each micro-LED to collimate the light emitted from the micro-LED.

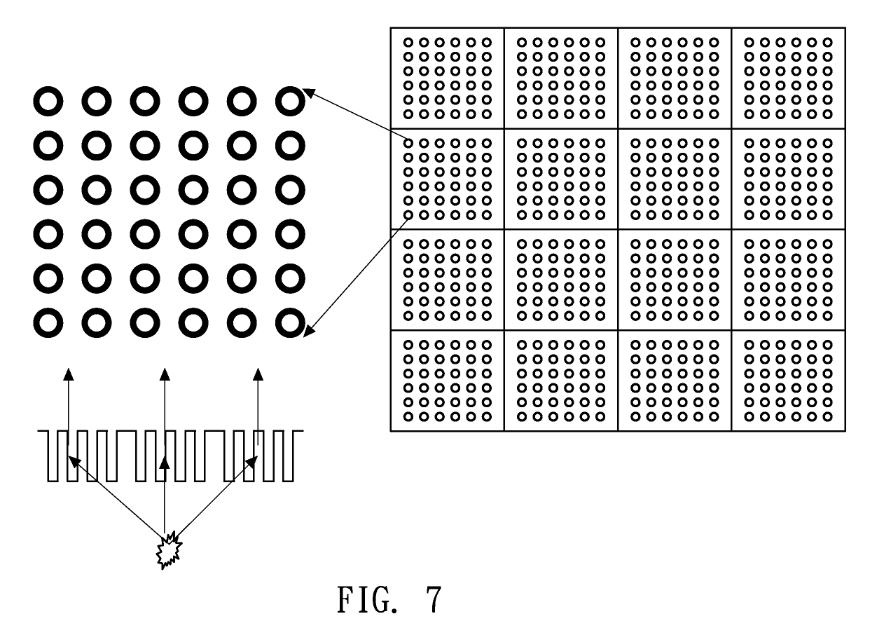

FIG. 7 shows the architecture of a photonic crystal array according to one exemplary embodiment. As shown in FIG. 7, which shows the top view of the photonic crystal array, the top view of a portion of the photonic crystal array and the side view of the photonic crystal array, the photonic crystal array collimates the light emitted from each micro-LED individually.

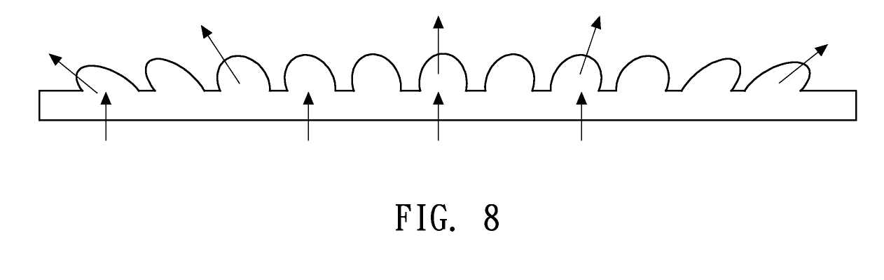

FIG. 8 shows a part of the micro light controlling structure 106 according to the one exemplary embodiment. As shown in FIG. 8, which shows the side view of the micro light controlling structure 106 shown in FIG. 1 along the axis I, the poly-axial micro projection lens array focuses the light emitted from each pixel and alters the projection direction by adjusting the geometrical structure of the lens. Poly-axial optic lens film is the key for focus-free projection. The poly-axial optic lens film is either formed directly on the aforementioned collimation devices by semiconductor manufacture process, or is formed in advance and then attached to the aforementioned collimation devices. Accordingly, lights are focused in different directions, and images can be displayed on any surface without enlargement by focusing the lens. The projection degree increases with the distance between each micro lens unit and the projection axis. The projection degree also depends on the projection distance and the throw ratio (projection distance/width of the image)

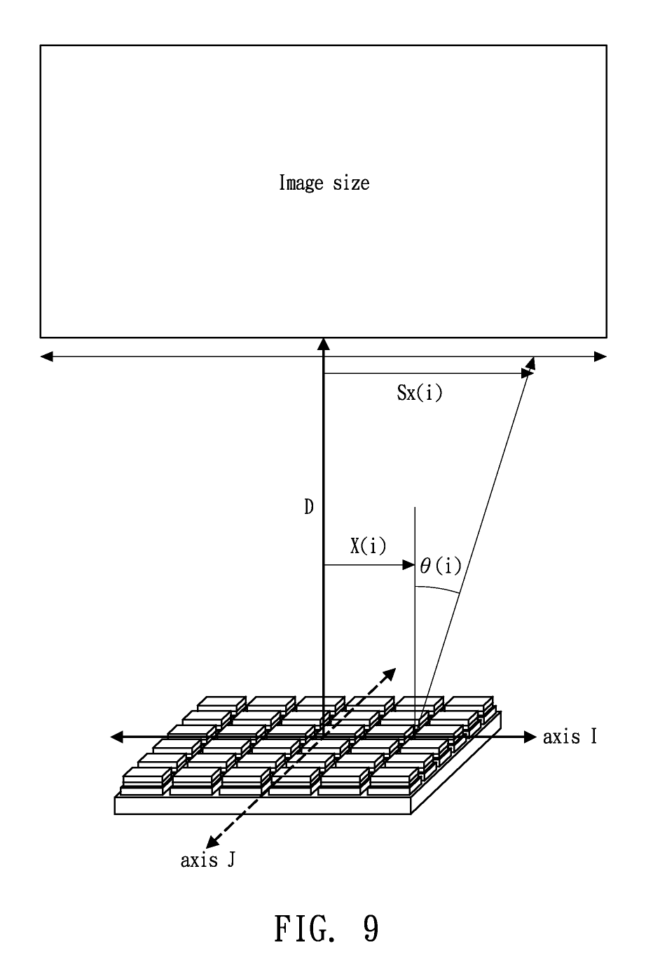

FIG. 9 shows the arrangement relation of the axis of the lens unit of the poly-axial micro projection lens array according to one exemplary embodiment. As shown in FIG. 9, the arrangement relation of the axis of the lens unit of the poly-axial micro projection lens array (only the axis I is marked) is shown. The size of the projection chip, i.e. the size of the poly-axial micro projection lens array, is X×Y. The resolution is represented as (Rx, Ry). The size of the projection image depends on the throw ratio (which is equal to D/(2Sx), wherein D represents the projection distance and 2Sx represents the image width). If the throw ratio is small, an image of a specific size can be displayed within a short distance. The poly-axial micro projection lens array is a two-dimensional array, wherein the angle of the projection axis (θ,φ) and the location (i, j) of each lens unit are mutually dependent, θ and i represent the angle and location pointer on the axis I, and φ and j represent the angle and location pointer on the axis J.

In the embodiments of this disclosure, the calculation of θ is as follows:

$$θ ( i ) = {tan}^{- 1} ( \frac{{s}_{x} ( i ) - x ( i )}{D} )$$

$${s}_{x} ( i ) = \frac{2 {S}_{x}}{{R}_{x}} i$$

$$x ( i ) = \frac{X}{{R}_{x}} i , i = - {R}_{x} / 2 to {R}_{x} / 2 , i ∈ Int .$$

The calculation of φ is as follows:

$$ϕ ( j ) = {tan}^{- 1} ( \frac{{s}_{y} ( j ) - y ( j )}{D} )$$

$${s}_{y} ( j ) = \frac{2 {S}_{y}}{{R}_{j}} j$$

$$y ( j ) = \frac{Y}{{R}_{y}} j , j = - {R}_{y} / 2 to {R}_{y} / 2 , j ∈ Int .$$

Accordingly, the directions of the axes of each lens unit of the poly-axial micro projection lens array can be defined based on the above equations.

During manufacture, the defined poly-axial micro projection lens array can be formed on the micro-LED array by semiconductor manufacture process. As shown in FIG. 4, multiple layer exposure mask technique is used to define the size of lens on each layer. Filming and etching techniques are also used to form layers of lenses with different axis directions.

In addition to the poly-axial micro projection lens array, the embodiments of this disclosure also provide a nanoscale structure formed on the micro LEDs, such as the photonic crystal array shown in FIG. 7, to maintain the vertical axes of these LEDs for images to be effectively projected and displayed on a screen. The photonic crystal is a nanoscale structure with periodically formed apertures, and such structure can be manufactured in the micro-LEDs by semiconductor manufacture process.

Photonic crystal is a device with surface grating. A diffraction theory is provided to analyze effect of the period of the photonic crystal structure on the light formation. The diffraction theory is as follows:
k_{g}sin θ₁+mG=k₀ sin θ₂, wherein k_{g} represents the wave vector of guided mode, G represents the diffraction vector of the photonic crystal, kₒ represents the wave vector of light in air and m represents the diffraction order.

For a guided mode in which light is trapped in the epilayer of the micro-LEDs, an inverse wave vector can be provided by the diffraction vector G such that the light can enter the air by diffraction. The far field light formation depends on the diffraction angle θ₂, the incident angle θ₁ and the value of the diffraction vector G, wherein the incident angle is determined by the guided mode, and different guided modes determine different incident angles. The characteristics of the guided modes are determined by the waveguide structure of the epilayer of the micro-LEDs. Therefore, a properly designed photonic crystal exhibits a period such that the most of the light diffraction angles θ₂ are perpendicular to the micro-LEDs, and therefore the collimation of the micro-LEDs' light beams is achieved.

Compared with the two-dimensional periodic aperture structure of the photonic crystal, the micro-ring type grating shown in FIG. 6 exhibits a one-dimensional periodic grating structure. The micro-ring type grating can be formed by etching the surface of the micro-LEDs to form a plurality of concentric recess regions by semiconductor manufacture process. The principles of the micro-ring type grating and the photonic crystal are the same. Therefore, the micro-ring type grating can also be designed according to diffraction theory.

FIG. 5 shows a grating structure formed by a nanoscale aperture structure surrounded by a metal film. Due to the surface plasmonic effect and aperture effect between the metal grating structure and the semiconductor material, a constructive interference perpendicular to the surface of the micro-LEDs is established, and a destructive interference away from the direction perpendicular to the surface of the micro-LEDs is also established. Therefore, a light field with an extremely high degree of collimation is obtained.

In conclusion, this disclosure provides a projection display chip, which can integrate light sources of traditional projector, display devices (such as DLP, LCoS and LCD), and optic lenses into a single chip without external light sources or projection lenses. Therefore, the projection display chip of this disclosure exhibits small size and high efficiency such that it can be easily integrated in a mobile device.

The above-described exemplary embodiments are intended to be illustrative only. Those skilled in the art may devise numerous alternative embodiments without departing from the scope of the following claims.

We claim:

1. A projection display chip, comprising:
a micro light emitting array including a plurality of micro light emitting units, wherein each micro emitting unit has a driving circuit device; and
a micro collimation array fabricated on the micro light emitting array, wherein the micro collimation array includes a plurality of micro collimation devices.

2. The projection display chip of claim 1, further comprising:
a projection lens configured to display a focused projection of an image provided by the projection display chip.

3. The projection display chip of claim 1, wherein the micro light emitting units are implemented by laser diodes.

4. The projection display chip of claim 1, wherein the micro light emitting units are implemented by Light Emitting Diodes (LEDs).

5. The projection display chip of claim 1, wherein the micro light emitting units are implemented by organic LEDs.

6. The projection display chip of claim 1, wherein the driving circuit devices are implemented by thin-film transistors.

7. The projection display chip of claim 1, wherein the driving circuit devices are implemented by Metal-Oxide-Semiconductor (MOS) transistors.

8. The projection display chip of claim 1, wherein the micro collimation devices are implemented by photonic crystals.

9. The projection display chip of claim 1, wherein the micro collimation devices are implemented by micro rings.

10. The projection display chip of claim 1, wherein the micro collimation devices are implemented by surface plasmonic apertures.

11. The projection display chip of claim 1, wherein the micro collimation devices are implemented by transparent dielectric lenses.

12. The projection display chip of claim 1, wherein the micro collimation devices are implemented by lenses.

13. A projection display chip, comprising:
a micro light emitting array including a plurality of micro light emitting units, wherein each micro emitting unit has a driving circuit device; and
a projection micro lens array fabricated on the micro light emitting array, wherein the projection micro lens array includes a plurality of micro lenses with different optical axes to enlarge projected images.

14. The projection display chip of claim 13, wherein the micro light emitting units are implemented by laser diodes.

15. The projection display chip of claim 13, wherein the micro light emitting units are implemented by LEDs.

16. The projection display chip of claim 13, wherein the micro light emitting units are implemented by organic LEDs.

17. The projection display chip of claim 13, wherein the driving circuit devices are implemented by thin-film transistors.

18. The projection display chip of claim 13, wherein the driving circuit devices are implemented by MOS transistors.

19. The projection display chip of claim 13, wherein the micro lenses are implemented by transparent dielectric lenses.

20. The projection display chip of claim 13, wherein the micro lenses are implemented by lenses.

21. A projection display chip, comprising:
a micro light emitting array including a plurality of micro light emitting units, wherein each micro emitting unit has a driving circuit device;
a micro collimation array fabricated on the micro light emitting array, wherein the micro collimation array includes a plurality of micro collimation devices; and
a projection micro lens array fabricated on the micro collimation array, wherein the projection micro lens array includes a plurality of micro lenses with different optical axes to enlarge projected images.

22. The projection display chip of claim 21, wherein the micro light emitting units are implemented by laser diodes.

23. The projection display chip of claim 21, wherein the micro light emitting units are implemented by LEDs.

24. The projection display chip of claim 21, wherein the micro light emitting units are implemented by organic LEDs.

25. The projection display chip of claim 21, wherein the driving circuit devices are implemented by thin-film transistors.

26. The projection display chip of claim 21, wherein the driving circuit devices are implemented by MOS transistors.

27. The projection display chip of claim 21, wherein the micro collimation devices are implemented by photonic crystals.

28. The projection display chip of claim 21, wherein the micro collimation devices are implemented by micro rings.

29. The projection display chip of claim 21, wherein the micro collimation devices are implemented by surface plasmonic apertures.

30. The projection display chip of claim 21, wherein the micro collimation devices are implemented by transparent dielectric lenses.

31. The projection display chip of claim 21, wherein the micro lenses are implemented by transparent dielectric lenses.

32. The projection display chip of claim 21, wherein the micro lenses are implemented by lenses.

33. A projection display chip, comprising:
a micro light emitting array including a plurality of micro light emitting units, wherein each micro emitting unit has a driving circuit device; and
a projection micro lens array fabricated on the micro light emitting array, wherein the projection micro lens array includes a plurality of micro adjustable lenses.

34. The projection display chip of claim 33, wherein focus and optical axes of the micro adjustable lenses are adjusted by electronic signals.
